(19) United States
(12) Patent Application Publication
(10) Pub. No.: US 2008/0239739 A1
(43) Pub. Date: Oct. 2, 2008

(54) Lighting Device For The Interior Of Motor Vehicles

(75) Inventor: Manfred Griesinger, Leonberg (DE)

Correspondence Address: CROWELL & MORING LLP;INTELLECTUAL PROPERTY GROUP, P.O. BOX 14300, WASHINGTON, DC, 20044-4300, US

(73) Assignee: Daimler Chrysler AG, Stuttgart (DE)

(21) Appl. No.: 11/659,981

(22) PCT Filed: Aug. 11, 2005
(86) PCT No.: PCT/EP2005/008731

§ 371 Date: Nov. 9, 2007

(30) Foreign Application Priority Data
Aug. 13, 2004 (DE) 10 2004 039 284.6

(51) Int. Cl. B60Q 3/02; F21V 21/14; F21V 5/04

(52) U.S. Cl. 362/488; 362/250; 362/244

(57) ABSTRACT

In a lighting device with low intensity light-emitting light sources for incident lighting of areas in a motor vehicle interior, the light sources are distributed in a mount above a converging lens, and aligned via the converging lens onto at least one area to be illuminated in the interior.

### BACKGROUND AND SUMMARY OF THE INVENTION

This application claims the priority of German patent document number 10 2004 039 284.6, filed Aug. 13, 2004 (PCT International Application No. PCT/EP2005/008731, filed Aug. 11, 2005), the disclosure of which is expressly incorporated by reference herein.

The invention relates to a lighting device for the interior of a motor vehicle, for non-glare lighting of controls with low intensity light-emitting sources.

So that controls in the interior of a vehicle may be located by a user as quickly and reliably as possible and without glare even in the dark, various solutions using low intensity light-emitting light sources or indirect lighting have recently been proposed.

German patent document DE 198 55 554 C2 describes a lighting device for lighting controls, wherein either linear areas in the surface of the control are background-lit by means of electroluminescent layers, which are mounted in undercut manner out of the driver's sight, or the controls are illuminated indirectly by subdued light, which is likewise produced by electroluminescent layers, which are accommodated in the vicinity of the relevant controls.

European patent document EP 1 101 654 A2 discloses to a lighting device for groups of instruments in vehicles, which is controlled by a motion detector, and switches on incident lighting in the vicinity of the group of instruments for the duration of operation.

The advantage of using incident light for lighting controls is that the user is oriented relative to the controls regarding the position of his or her operating hand. Incident lighting significantly reduces the time during which the operator is distracted from the traffic for an operating procedure, in comparison with operating elements which are merely labeled with luminous symbols, because, without the assistance of incident light, the user can neither ascertain the precise form thereof nor follow how precisely his or her fingers are approaching their target. However, the previously proposed solutions for incident lighting are firstly feasible only for very specific arrangements of controls around the steering wheel, and require additional structural space in order to be able to make the lighting of the instrument group in question non-glare.

These problems may be avoided if, according to EP 0 719 674 B1, light-emitting diodes or other low intensity light-emitting light sources are used. The latter may be installed for example in the bottom of the internal rear view mirror or in the mount thereof, which may be in the roof area, or in the ceiling lighting, (i.e., in a position suitable for non-glare lighting at a relatively large distance from the controls to be lit). Each of the light sources is provided with an integral optical system, such that the individual controls are lit specifically.

Controls in different areas of the motor vehicle may thus be lit with incident light by light sources at different installation locations. From the point of view of installation, however, the provision of a plurality of different installation locations is difficult.

One object of the invention is to, provide a lighting device which allows non-glare lighting of a plurality of controls in the motor vehicle interior in a manner involving little installation difficulty.

This and other objects and advantages are achieved by the lighting device according to the invention, in which low intensity light-emitting light sources are placed in a distributed manner in a mount above a converging lens and aligned via the lens onto one or more areas to be lit in the interior, which allows non-glare incident lighting in the motor vehicle interior. When the light sources are appropriately arranged, aligned and distributed above the lens, using just one central optical system, the lighting device according to the invention, allows directed incident lighting of an extremely wide range of areas in the interior of a motor vehicle. Since, in this arrangement, the light sources are all individually actuatable, different areas or controls may also be lit wholly independently of one another.

Installation of the control device according to the invention is simple, requiring only one installation location for lighting different areas in the vehicle. In this way, highly branched wiring paths, such as are necessary for distributed individual light sources, are dispensed with.

The use of low intensity light-emitting light sources, whose light is concentrated by the optical lens onto the areas to be lit, avoids disturbingly large bright-dark variations, such as occur when incandescent lamps are used. No distracting reflections arise in the vehicle either, because the light source is not located directly on a surface in the interior of the vehicle but rather is “hidden” behind the lens. By arranging the light sources behind a large lens, the light sources are also well protected from inadvertent adjustment or indeed from damage.

The lighting device according to the invention may advantageously be installed in the roof lining of a vehicle interior, and when so installed (for example on the axis between the driver's seat and passenger seat), a wide area in the vehicle interior may be reached for incident lighting. By inclining the lens appropriately in relation to the roof lining plane, it is easy to establish an area which is preferentially to be illuminated in the vehicle interior.

If the light sources are attached to the mount in such a way that the center point of a light source and the center point of the area to be illuminated lie substantially on a straight line through the optical center point of the converging lens, a particularly well defined light spot is obtained for the area lit in each case. According to optical laws, an approximately straight line is obtained only with thin lenses for the beam path described; in the case of thicker lenses, parallel displacement of the beam path occurs, which may however be simply compensated by trial and error. The sharpness or definition of the light spot imaged by the converging lens is influenced, in accordance with optical laws, by the distance between the light source and the lens or the focal point thereof and the distance between the lit area and the lens and—to a certain degree—by the specific properties of the light source used itself.

However, since it is sufficient for the purpose of incident lighting in the vehicle interior to have a clearly perceptible light spot on the area to be lit, it is not absolutely necessary to optimize the spacing of the light sources, for each individual area to be lit, with regard to imaging sharpness. It is even the case that the pattern produced by sharp imaging on a surface, brought about by the structure of the light source used, is not wholly desirable for aesthetic reasons, and therefore focused but slightly blurred (and thus diffuse), softer imaging of the light source is advantageous. As far as this consideration is concerned, it is sufficient for the light sources for all the areas to be lit to be fitted on the mount equidistantly from the converging lens, wherein the spacing may be optimized for lighting certain areas by well focused light spots. Attaching the light sources in this manner also simplifies production of the lighting device.

Use of a spherical lens as a converging lens advantageously allows the widest possible area to be illuminated in the interior of the vehicle. In the case of a spherical lens, light beams are equally well imaged from all directions. Specific alignment or orientation of the lens relative to a preferred area of the vehicle interior becomes superfluous, since the imaging properties of the sphere are identical at every point due to the symmetry of the lens. Thus, when a spherical lens is used, light spots may be simply defined at any desired location by positioning the light source opposite the center point of the sphere, which is at the same time the optical center point of the lens.

If this embodiment of the lighting device is installed in the roof lining at a central point of the roof lining (for example in the area between the headrests of the front seats), areas or controls on the instrument panel, the central console, the floor console and the side consoles, as well as the glove compartment, areas in the foot well or zones at reading distance from the driver or passenger may be lit with incident light by means of the spherical lens and the low intensity light-emitting light sources located therebehind. Similarly, areas in the rear of the vehicle may be lit in a directed manner without the driver being disturbed by glare; as a result, with this embodiment it is possible, for example, simultaneously also to provide a reading light for rear passengers. The lighting device may also be placed in other positions in the roof lining or additionally incorporated into conventional ceiling lighting.

The low intensity light-emitting light sources for the lighting device according to the invention may advantageously take the form of light-emitting diodes, which diodes have a long life span, consume little current and produce almost no heat. They are insensitive to vibration, allow precise direction of light and thus good delimitation of glare. Since light-emitting diodes may now also be obtained in white, neutral lighting situations may also be achieved therewith, as is suitable for example for lighting in a vehicle interior. However, the lighting device may also be equipped with light sources of various colors, whereby for example certain situations or events may be signaled. Colors may additionally be used to produce atmospheric or brand-specific impressions. Of course, electroluminescence or semiconductor laser diodes or indeed vacuum fluorescence sources may also be used for the purpose of the lighting device according to the invention.

If smaller controls, such as for example switches or rotary knobs, are to be lit with the lighting device according to the invention, it is sufficient to locate an individual low intensity light-emitting light source for each control that is to be lit, at an appropriate point on the mount behind the converging lens for lighting such control. The area illuminated by the light source may advantageously be determined by the size of the light source used, since a larger light source through the converging lens produces a larger image than a comparably arranged smaller light source. If larger areas, such as for example an area in the glove compartment, are to be illuminated, or if a reading light is to be produced, the extent of the area to be illuminated may advantageously be determined by a number of adjoining light sources, by fitting an appropriate number of light sources of suitable sizes next to one another on the mount behind the lens to form an optionally curved surface, with their image produced by the optical system extending as desired.

The size of the imaged light spot may also be simply adjusted to a certain extent by means of the distance between the light source and the converging lens. The light intensity of a spot enlarged in this way is less than that of a smaller or sharply imaged light spot.

Accordingly, the extent of the lit area may also be varied by varying the distance between the imaging surface and the lens, though it is not really possible to influence the interior lighting in the vehicle in this way since the position of the interior to be lit is fixed. However, the influence of the distance between the imaging surfaces and the optical system may be taken into account when establishing where to install the optical system or when designing the interior.

The alignment of the imaging surfaces relative to the alignment of the light source with the lens also has an influence on imaging of the light sources: if the imaging surface is not aligned perpendicularly to the optical axis, blurring occurs. This is of course of no relevance if sharp imaging is not required, but may be easily compensated by appropriate alignment of the light source relative to the lens surface where the opposite is true.

The converging lens of the lighting device according to the invention is advantageously made of acrylic polymer, which is optically of very high quality: it has no inherent color and transmits more light than glass, for example. Due to its fracture strength and its thermal shock resistance, it is ideally suited to use in a vehicle as far as safety requirements and loading conditions are concerned.

The mount in which the light sources may be placed advantageously takes the form of a spherically shaped grid. The light sources may then be simply adhered or soldered to the struts of the grid, or the mesh of the grid may be so fine that the light sources may be inserted into the mesh of the grid network, so doing away with the complexity of the above-stated or other modes of fastening. During fastening in or on a grid, there are also no problems relating to laying of the lead wires associated with the light sources, in contrast to continuous mounts, since the lead wires automatically come to lie on the outside of the grid through the openings.

The grid may be made of metal or plastics for example, thus ensuring sufficient resilience for the light sources to be inserted into the grid mesh. If the grid is spherical (for example parallel to the lens sphere), all the light sources may readily be attached to the sphere with equal spacing. If the imaging of individual light sources is to be specially optimized, the light sources may be re-adjusted in the grid mesh. However, the grid may also be shaped deliberately to deviate from spherical, such that the imaging of light spots whose points of incidence in the vehicle interior are at very different distances from the lens may be optimized by spacing the light source closer to or further away from the lens.

In order to fasten the converging lens of the lighting device according to the invention simply in the roof lining, the lens is advantageously inserted fixedly in a fastening plate, which is provided for installation of the entire device in the roof lining. By inserting the converging lens fixedly in an exact-fitting recess in such a plate corresponding to the outline of the lens, for example by adhesion or welding, the lens is also protected from falling out even in the event of vibration. A recess reproducing the outline of the lens separates the light sources located above the lens completely and in leakproof manner from the interior of the vehicle. This arrangement ensures that no disturbing stray light enters the passenger compartment directly from above the fastening plate. The fastening plate itself, which may readily be adapted to the requirements for installation in the roof lining, plate may consist of the same material as the lens, in order to obtain a stable bond even with regard to relatively severe temperature variations.

Furthermore, the fastening plate may advantageously be so designed that intentional or necessary alignment of the converging lens (this applies in particular to non-spherical lenses) is effected by appropriate inclination of the recess in the fastening plate accommodating the lens. This measure also contributes to the simplicity of installation.

Installation of the lighting device may advantageously be further simplified by fastening the mount for accommodating the light sources on the fastening plate. As a consequence, free access may be provided for alignment of the light sources in the mount with the area in each case to be illuminated thereby, optionally with the assistance of a check device, prior to installation of the lighting device in the vehicle. In this way, complex adjustment of the light sources is unnecessary on installation of the lighting device, which the lighting device may be installed in one piece in the roof lining.

It is also advantageous if the light sources of the lighting device may be individually switched on and off by a control unit. In this way, the lighting device may for example provide a reading light for the front passenger or even for the rear passengers without diverting the attention of the driver to other, lit areas of the interior. The particular reading light may then for example be switched on or off by means of a switch, which is connected to the control unit via wires and which is located within reach of the seat. This type of purposeful, user-controlled operation of the device for lighting given areas is particularly suitable for satisfying the desires of the front passenger or rear passengers for directed lighting.

For the driver, however, it would be awkward to have to switch on a light before performing an intended control operation, even if it were feasible to accommodate in the steering wheel such a light switch for switching on lighting for the most important controls. However, this would entail an additional operating step before the actually intended operating step. For the driver it is substantially more convenient and safe for his/her intended control operations to be automatically detected and for the appropriate controls to be automatically lit up as a result of the detected intended control operation. Detection of the intended control operation is advantageously achieved with the assistance of sensors for detecting an intended control operation, wherein the sensors are connected to the control unit, which switches given light sources on or off in accordance with the signals received from sensors. Such sensors may take the form, for example, of proximity or motion sensors, which are installed in the immediate vicinity of the controls.

The control unit may also be used for the purpose of receiving further signals (for example relating to vehicle condition), and converting them into a change in lighting color if the lighting device is equipped appropriately with colored light sources.

Other objects, advantages and novel features of the present invention will become apparent from the following detailed description of the invention when considered in conjunction with the accompanying drawings.

### BRIEF DESCRIPTION OF THE DRAWINGS

FIG. 1 illustrates a lighting device according to the invention; and

FIG. 2 shows the grid to which light sources are mounted.

### DETAILED DESCRIPTION OF THE INVENTION

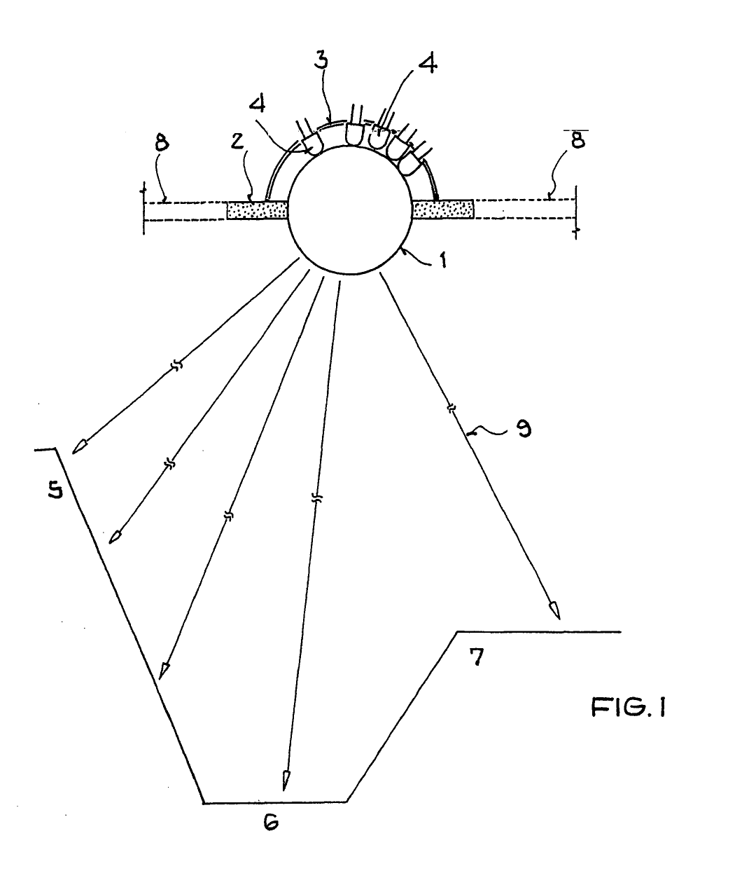

FIG. 1 shows the lighting device according to the invention, fastened in the roof lining 8 by means of the fastening plate 2 and having a spherical lens as converging lens 1, a mount 3 arching thereover and the light sources 4 fastened therein. The lower part of the figure contains a schematic longitudinal section through a vehicle showing the imaging surfaces, illuminated by the light sources 4 of the lighting device, in the instrument panel area 5, in the gear shift area 6 and the central console 7 and the associated imaging paths 9.

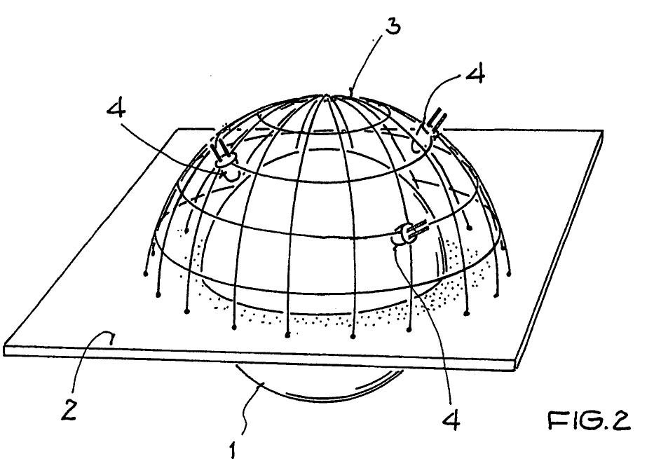

FIG. 2 shows an embodiment of the lighting device with spherical lens 1, fastening plate 2 and a mount 3, which takes the form of a grid, to which light sources 4 are for example adhered or soldered. The grid mesh may be finer than illustrated or for example take the form of loops, such that it is possible to fasten the light sources in the mount merely by inserting them in the meshes. Fastening by insertion may also be achieved for example by using an appropriately curved perforated plate as a mount.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-13. (canceled)

14. A device for incident lighting of areas in a motor vehicle interior, said device comprising:
a plurality of low intensity light-emitting light sources; and
a converging lens; wherein,
the light sources are placed in a distributed manner in a mount above said converging lens; and
the light sources are aligned via the converging lens onto at least one area to be illuminated in the interior.

15. The device as claimed in claim 14, wherein the converging lens is fastened in the roof lining of the vehicle.

16. The device as claimed in claim 14, wherein a center point of at least one light source and a center point of the area to be illuminated thereby lie substantially on a straight line through an optical center point of the converging lens.

17. The device as claimed in claim 14, wherein the converging lens is a spherical lens.

18. The device as claimed in claim 14, wherein the light sources are light-emitting diodes.

19. The device as claimed in claim 14, wherein the extent of the illuminated areas is determined by the number or size of adjoining light sources on the mount.

20. The device as claimed in claim 14, wherein the converging lens comprises an acrylic polymer.

21. The device as claimed in claim 14, wherein the mount is a spherically shaped grid.

22. The device as claimed in claim 14, wherein the converging lens (1) is inserted fixedly in a recess, corresponding to the outline of the converging lens, in a fastening plate and is fastened by means thereof in the roof lining.

23. The device as claimed in claim 22, wherein an intended alignment of the converging lens is predetermined by inclination of the recess in relation to the fastening plate.

24. The device as claimed in claim 22, wherein the mount is fastened to the fastening plate.

25. The device as claimed in claim 14, wherein the light sources are connected to and are switchable on and off individually by, a control unit.

26. The device as claimed in claim 25, further comprising:
sensors connected to the control unit for detecting an intended control operation; and
wherein predetermined light sources may be switched on or off by the control unit in accordance with signals received from the sensors.

27. A light source for selectively illuminating targeted areas, said light source comprising:
a converging lens;
a mounting structure disposed adjacent to said converting lens, and having a contour that accommodates an adjacent contour of the converging lens;
a plurality of light sources mounted on said mounting structure, facing toward said adjacent contour of said converging lens; and
control means for illuminating selected ones of said light sources, opposite said targeted area.

28. The light source according to claim 27, wherein said converging lens is a spherical lens.

29. The light source according to claim 27, wherein said light sources are light emitting diodes.

30. The light source according to claim 27, wherein said control means controls an extent and location of an illuminated area by controlling the number and size of adjoining light sources which are illuminated.

31. The light source according to claim 27, wherein a center point of at least one light source and a center point of the targeted area lie substantially on a straight line through an optical center point of the converging lens.
